(19) United States
(12) Patent Application Publication
(10) Pub. No.: US 2007/0064648 A1
(43) Pub. Date: Mar. 22, 2007

(54) Method and system for hand-over from wideband code division multiple access network to code division multiple access network by using dummy pilot signal

(75) Inventors: Young-Iak Kim, Gyeonggi-do (KR); Sungho Shin, Seoul (KR); Jongtae Ihm, Gyeonggi-do (KR)

Correspondence Address: LAHIVE & COCKFIELD, LLP, ONE POST OFFICE SQUARE, BOSTON, MA, 02109-2127, US

(73) Assignee: SK Telecom Co., Ltd., Jung-gu (KR)

(21) Appl. No.: 10/579,348

(22) PCT Filed: Nov. 15, 2004
(86) PCT No.: PCT/KR04/02956

§ 371 Date: May 12, 2006

(30) Foreign Application Priority Data
Nov. 14, 2003 (KR) 2003-80434

(51) Int. Cl. H04Q 7/00

(52) U.S. Cl. 370/331; 455/436

(57) ABSTRACT

Disclosed are a method and a system for handover from a WCDMA network to a CDMA-2000 network by using a dummy pilot signal. The method comprises the steps of: a) a multimode terminal receiving a WCDMA signal level measurement message, turning on a CDMA-2000 modem mounted on the multimode terminal and transmitting a level value of the dummy pilot signal to a WCDMA system, when detecting the dummy pilot signal above a specific level from the WCDMA signal level measurement message; b) the WCDMA system determining whether to perform a handover or not based on the level value of the dummy pilot signal; c) the WCDMA system transmitting a handover request message to a CDMA-2000 system when it is determined to perform the handover; d) transmitting a handover command message from the WCDMA system to the multimode terminal; and e) allowing traffic to be switched to the CDMA-2000 modem of the multimode terminal.

### TECHNICAL FIELD

The present invention relates to a method and a system for handover from a Wideband Code Division Multiple Access network (hereinafter, referred to as WCDMA network) to a Code Division Multiple Access network (hereinafter, referred to as CDMA-2000 network) by using a dummy pilot signal. More particularly, the present invention relates to a method and a system, in which a CDMA-2000 system transmits a dummy pilot signal, which is a specific pilot signal of a WCDMA, so that the method and the system can perform a handover from a WCDMA network to a CDMA-2000 network by means of the intensity of the dummy pilot signal even without detecting the signals of the CDMA-2000 network.

### BACKGROUND ART

Mobile communication services have been continuously developed from voice communication-centered 1 G mobile communication services of low quality provided from Advanced Mobile Phone Services (AMPS) of an analog cellular scheme having begun its provision of service from the latter half of 1980's. Further, in the 2 G mobile communication services, it is possible to provide advanced voice communication and low speed (14.4 Kbps) data services through a Global System for Mobile (GSM), a CDMA, a Time Division Multiple Access (TDMA), etc., of a digital cellular scheme. Furthermore, in the 2.5 G mobile communication services, it is also possible to provide advanced voice communication and low speed (144 Kbps) data services due to the preparation of the frequency of a GHz band and the development of a Personal Communication Service (PCS) capable of being used in the whole world.

A mobile communication network for the mobile communication services from the 1 G to the 2.5 G includes various communication equipments such as User Equipments (UE), Base Transceiver Systems (hereinafter, referred to as BTS), Base Station Controller (hereinafter, referred to as BSC), Mobile Switching Centers (MSC), Home Location Register (HLR) and Visitor Location Register (VLR).

The 3 G mobile communication services are provided by an asynchronous WCDMA system mainly proposed by the 3^{rd} Generation Partnership Project (hereinafter, referred to as 3GPP) and a synchronous CDMA-2000 system mainly proposed by the 3GPP2. In particular, a WCDMA system employs a wireless protocol recommended by an IMT-2000, and many communication service providers in the world have provided the services through the WCDMA system or have prepared the provision of the services.

The CDMA-2000 system has been already constructed in South Korea and has covered the whole country, thereby having a wide service coverage. Further, as the CDMA-2000 system employs an EV-DO scheme, the CDMA-2000 system has a high transmission rate of 2.4 Mbps at maximum in a forward direction. However, since the CDMA-2000 system has a wide variation of a transmission rate depending on wireless environments, the CDMA-2000 system is not competent for a service requiring high Quality of Service (hereinafter, referred to as QoS) such as a picture phone.

In contrast, a WCDMA system has an advantage in that it is suitable for a large volume of data transmission, because it has high call quality and uses a spread spectrum scheme. Further, a WCDMA communication scheme employs a 32 Kbps Adaptive Differential Pulse Code Modulation (ADPCM) scheme for a voice coding and supports high mobility enough for allowing communication to be performed even though a user moves at a speed of about 100 Km/h, so that the WCDMA system is proper for realtime service similarly to the case of a picture phone. Furthermore, many countries have employed a WCDMA communication scheme and a 3GPP including many organizations of South Korea, Europe, Japan, U.S.A., China, etc., has continuously developed technical specifications for a WCDMA. However, since a WCDMA system requires enormous initial investment cost for commercialization, it is difficult to provide a nationwide service.

Accordingly, it is anticipated that a WCDMA network coexists with a CDMA-2000 network at an early IMT-2000 stage and thus a service using a multimode terminal emerges. Herein, when a voice service, a high speed Internet access service, etc., use the CDMA-2000 network and a service such as a picture phone which requires high QoS uses the WCDMA network, it is possible to exploit each advantage of the two networks. Because of this advantage, countries, such as South Korea, Japan, U.S.A., China, etc., having basically provided a CDMA-2000 service have also constructed a WCDMA network and have started to provide a WCDMA service.

Herein, in order to accommodate both the CDMA-2000 service and the WCDMA service, a multimode terminal is necessary. A multimode terminal is a communication terminal supporting a multimode and a multiband. Herein, the multimode includes a synchronous mode, an asynchronous mode, etc. Further, a service using the multiband includes the 2 G mobile communication service using a frequency band of 800 MHz, the 2.5 G mobile communication service using a frequency band of 1.8 GHz, the 3 G mobile communication service using a frequency band of about 2 GHz, and the 4 G mobile communication service to be provided later. The multimode terminal switches to a WCDMA mode, a CDMA-2000 mode, etc., according to the type of communication services provided in the area where the multimode terminal is located and operates in a switched mode. For this operation, the multimode terminal includes both a WCDMA modem and a CDMA-2000 modem. In this case, when simultaneously using the two modems, the multimode terminal consumes an inordinate amount of power. Therefore, the battery lifetime of the multimode terminal is shortened. Accordingly, the multimode terminal always turns on only one of the two modems, so that the multimode terminal cannot simultaneously connect to a CDMA-2000 network and a WCDMA network.

FIG. 1 is a diagram schematically showing a mobile communication network in which a CDMA-2000 network and a WCDMA network coexist.

A WCDMA service is provided in a part of a CDMA-2000 region 110 in which a CDMA-2000 service is provided. An area of the CDMA-2000 region 110, in which the WCDMA service is provided, is called overlay areas 120 and 130. That is, a user can selectively receive a desired one of the CDMA-2000 service and the WCDMA service provided in the overlay areas 120 and 130. Further, it is necessary to use the aforementioned multimode terminal 124 in order to receive the CDMA-2000 service and the WCDMA service.

Herein, in a state in which the WCDMA network is not a nationwide network, when the multimode terminal 124 moves from the overlay areas 120 and 130 to the CDMA-2000 region 110 in which the WCDMA service is not provided as shown in FIG. 1, a call may be interrupted_if a handover is not supported in a border area 130 of the WCDMA network. That is, when the multimode terminal 124 having received the service under the control of the a Radio Network Controller 122 (hereinafter, referred to as RNC), which belongs to a WCDMA system, moves the CDMA-2000 region 110, the multimode terminal 124 must exchange signals with Base Transceiver Systems (BTSs) 112 and 114 controlled by a Base Station Controller (BSC) which belongs to a CDMA-2000 system. Accordingly, in order to provide a service without a call drop, a handover must be supported in the border area 130.

However, a WCDMA scheme and a CDMA-2000 scheme are completely different from each other in view of a wireless transmission scheme and of a protocol. Accordingly, various conditions must be satisfied in order to allow a handover to be performed between these heterogeneous networks.

First, the multimode terminal 124 should be capable of detecting the signals of the CDMA-2000 network during communication using the WCDMA scheme. However, as described above, the current multimode terminal 124 always turns on only one of a WCDMA modem and a CDMA-2000 modem, which means the multimode terminal 124 cannot simultaneously connect to both the CDMA-2000 network and the WCDMA network. Therefore, the multimode terminal 124 cannot detect the signals of the CDMA-2000 network during communication using the WCDMA scheme.

Further, in order to allow a handover to be performed between the WCDMA network and the CDMA-2000 network, it is necessary to define a message for the handover between the multimode terminal 124 and the networks. Herein, the WCDMA scheme and the CDMA-2000 scheme have been currently defined and managed according to international standards. However, a message used for performance of the handover between the WCDMA network and the CDMA-2000 network is not defined in the international standard. Local definition and use of such a message may bring about big problem in an international roaming, etc., of a terminal in the future.

Further, in order to allow the handover to be performed between the WCDMA network and the CDMA-2000 network, a WCDMA system must inter-work with a CDMA-2000 system. However, it is impossible to accomplish such an interworking between the two heterogeneous systems.

### DISCLOSURE OF THE INVENTION

Therefore, the present invention has been made in view of the above-mentioned problems, and it is an object of the present invention to provide a method and a system, in which a CDMA-2000 system transmits a dummy pilot signal, which is a specific pilot signal of a WCDMA, so that the method and the system can perform a handover from a WCDMA network to a CDMA-2000 network by means of the intensity of the dummy pilot signal even without detecting the signals of the CDMA-2000 network.

According to one aspect of the present invention, there is provided a method for performing a handover from a WCDMA network to a CDMA-2000 network by using a dummy pilot signal, the method comprising the steps of: (a) receiving a WCDMA signal level measurement message at a multimode terminal, turning on a CDMA-2000 modem mounted on the multimode terminal and transmitting a level value of the dummy pilot signal to a WCDMA system, upon detecting the dummy pilot signal above a prescribed level out of the WCDMA signal level measurement message; (b) determining whether to perform a handover or not based on the level value of the dummy pilot signal received from the multimode terminal; (c) transmitting a handover request message from the WCDMA system to a CDMA-2000 system when it is determined to perform the handover; (d) transmitting a handover command message from the WCDMA system to the multimode terminal; and (e) allowing traffic to be switched to the CDMA-2000 modem of the multimode terminal.

According to another aspect of the present invention, there is provided a method for performing a handover from a WCDMA network to a CDMA-2000-network by means of a WCDMA system for determining whether to perform the handover or not, a CDMA-2000 system for transmitting a dummy pilot signal, and a multimode terminal including a WCDMA modem and a CDMA-2000 modem, the method comprising the steps of: (a) receiving a WCDMA signal level measurement message at a multimode terminal; (b) detecting the dummy pilot signal from the WCDMA signal level measurement message and comparing a level value of the dummy pilot signal with a predetermined threshold value; (c) turning on a CDMA-2000 modem and transmitting the level value of the dummy pilot signal to the WCDMA system, when the level value of the dummy pilot signal is larger than the predetermined threshold value; (d) determining whether to perform the handover or not based on the level value of the dummy pilot signal at the WCDMA system; (e) transmitting a handover request message to the CDMA-2000 system when it is determined to perform the handover at the WCDMA system; (f) transmitting a handover command message from the WCDMA system to the multimode terminal; and (g) allowing traffic to be switched to the CDMA-2000 modem of the multimode terminal.

According to further another aspect of the present invention, there is provided a system for performing a handover from a WCDMA network to a CDMA-2000 network by means of a dummy pilot signal, the system comprising: a multimode terminal for receiving a WCDMA signal level measurement message, turning on a CDMA-2000 modem embedded in the multimode terminal and transmitting a level value of the dummy pilot signal, when detecting the dummy pilot signal above a prescribed level out of the WCDMA signal level measurement message; a WCDMA system for receiving the level value of the dummy pilot signal from the multimode terminal, determining whether to perform the handover, and transmitting a handover request message or a handover command message; and a CDMA-2000 system for transmitting the dummy pilot signal to the multimode terminal.

According to still another aspect of the present invention, there is provided a WCDMA system for performing a handover from a WCDMA network to a CDMA-2000 network by means of a dummy pilot signal, the WCDMA system comprising: a radio transceiver subsystem (RTS) for receiving a level value of the dummy pilot signal from a multimode terminal and transmitting the received level value of the dummy pilot signal; and a radio network controller for receiving the level value of the dummy pilot signal from the radio transceiver subsystem, determining whether to perform the handover for the multimode terminal, and transmitting a handover request message or a handover command message.

According to yet another aspect of the present invention, there is provided a CDMA-2000 system for performing a handover from a WCDMA network to a CDMA-2000 network by means of a dummy pilot signal, the CDMA-2000 system comprising: a base transceiver station (BTS) for transmitting the dummy pilot signal, which is a WCDMA pilot signal including a specific scramble code assigned in advance, to the multimode terminal; and a base station controller (BSC) for receiving a handover request message from a WCDMA system.

According to yet another aspect of the present invention, there is provided a multimode terminal capable of using both synchronous CDMA-2000 service and asynchronous WCDMA service and using at least two frequency bands, the multimode terminal comprising: an RF antenna for transmitting/receiving CDMA-2000 signals and/or WCDMA signals; an RF transmission/reception unit for receiving and demodulating a dummy pilot signal sent from the RF antenna, and outputting a demodulated dummy pilot signal; a pilot signal measurement unit for measuring intensity of the demodulated dummy pilot signal; a WCDMA modem and a CDMA-2000 modem for processing a digital signal received from the RF transmission/reception unit and performing a call processing according to protocols respectively defined in a WCDMA standard and a CDMA-2000 standard; a flash memory for storing an inter-modem switching program for performing a switching between the WCDMA modem and the CDMA-2000 modem according to a command from a WCDMA system; and a controller for turning on the CDMA-2000 modem and controlling a level value of the dummy pilot signal to be transmitted to the WCDMA system, when the dummy pilot signal above a specific level is detected.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a diagram schematically showing a mobile communication network in which a CDMA-2000 network and a WCDMA network coexist;

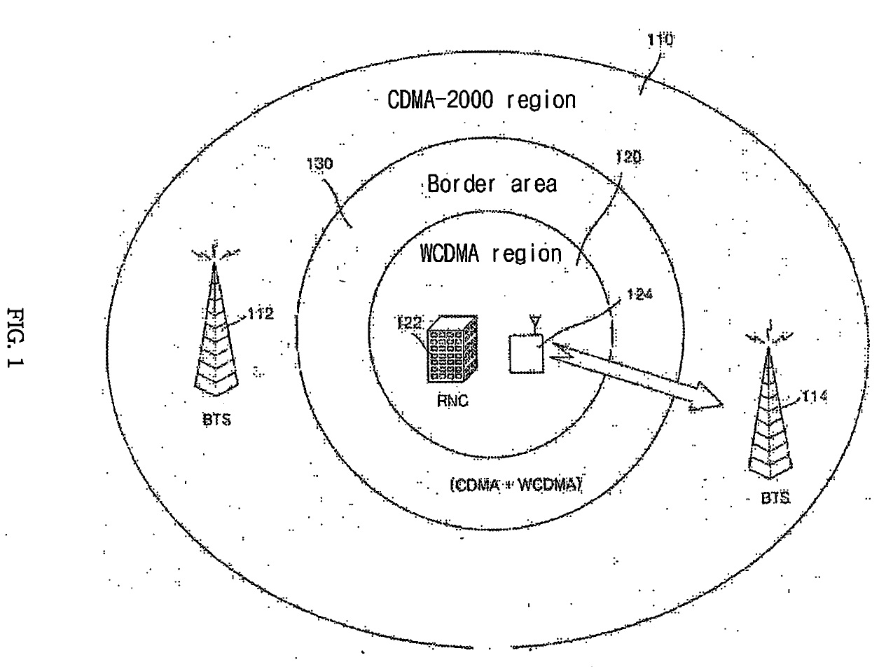

FIG. 2 is a diagram schematically showing the structure of a network for a handover according to a preferred embodiment of the present invention;

FIG. 3 is a block diagram showing a system performing a handover from a WCDMA network to a CDMA-2000 network by means of a dummy pilot signal according to a preferred embodiment of the present invention;

FIG. 4 is a block diagram showing the construction of a multimode terminal according to a preferred embodiment of the present invention;

FIG. 5 is a diagram illustrating an operation condition of a CDMA-2000 modem when a multimode terminal moves from WCDMA regions to a CDMA-2000 region according to a preferred embodiment of the present invention; and

FIG. 6 is a flow diagram illustrating a handover process using a dummy pilot signal from a WCDMA network to a CDMA-2000 network according to a preferred embodiment of the present invention.

### BEST MODE FOR CARRYING OUT THE INVENTION

Reference will now be made in detail to the preferred embodiments of the present invention. The same reference numerals are used to designate the same elements as those shown in other drawings. In the following description of the present invention, a detailed description of known configurations and functions incorporated herein will be omitted when it may make the subject matter of the present invention rather unclear.

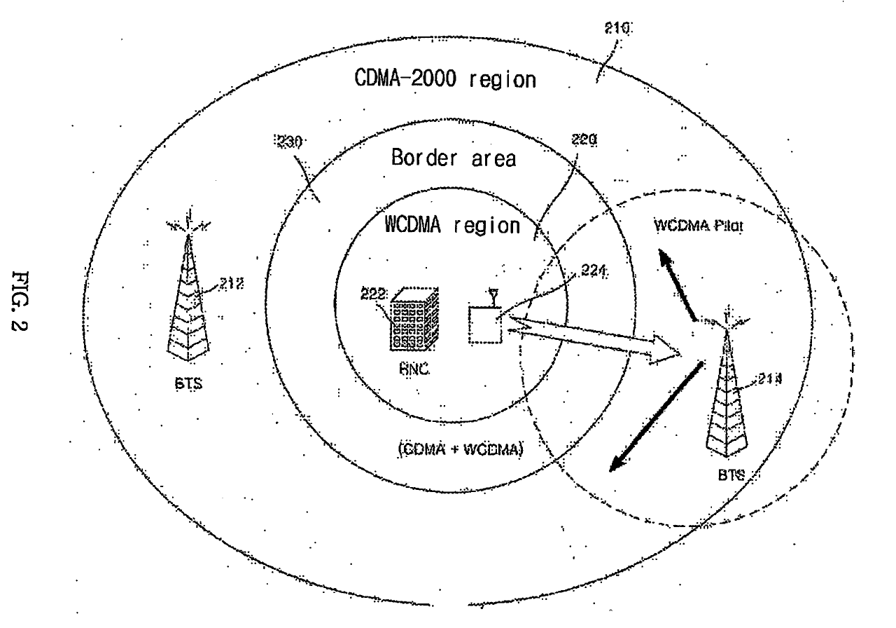

FIG. 2 is a diagram schematically showing the structure of a network for a handover according to a preferred embodiment of the present invention.

Referring to FIG. 2, it is unnecessary to support a handover when a multimode terminal 224 moves from a CDMA-2000 region 210 to WCDMA regions 220 and 230. Since the CDMA-2000 network is a nationwide network, so that a WCDMA region and a CDMA-2000 region always overlap. Accordingly, there is no possibility of call interruption during voice communication because the WCDMA network can be searched after the voice communication based on a service provided through a CDMA-2000 scheme is completed. In contrast, when the multimode terminal 224 moves from the WCDMA region 220 or 230 to the CDMA-2000 region 210, a handover must be supported. The present invention supports a handover when the multimode terminal 224 moves from the WCDMA regions 220 and 230 to the CDMA-2000 region 210.

According to the preferred embodiment of the present invention, the multimode terminal 224 uses a method of sending signal level measurement information to an RNC 222 which is a WCDMA system without the necessity of detecting the signals of a CDMA-2000 network for performance of a handover, thereby enabling a handover using a dummy pilot signal. Herein, the dummy pilot signal denotes a specific pilot signal of a WCDMA sent from BTSs 212 and 214 located in a border area 230 of the CDMA-2000 region 210 and the WCDMA regions 220 and 230. Generally, in order to distinguish a pilot signal from other signals, a Scramble Code is used. That is, a specific Scramble Code is assigned in advance. In this way, the multimode terminal 224 detects a WCDMA dummy pilot signal without the necessity of detecting the signals of the CDMA-2000 network, so that the multimode terminal 224 can request a handover. Accordingly, the multimode terminal 224 does not require the detection of the BTSs 212 and 214 during communication using a WCDMA scheme, so that the multimode terminal 224 can use a handover parameter and message defined in an existing WCDMA scheme. Therefore, it is possible to perform a handover even without the change of an international standard.

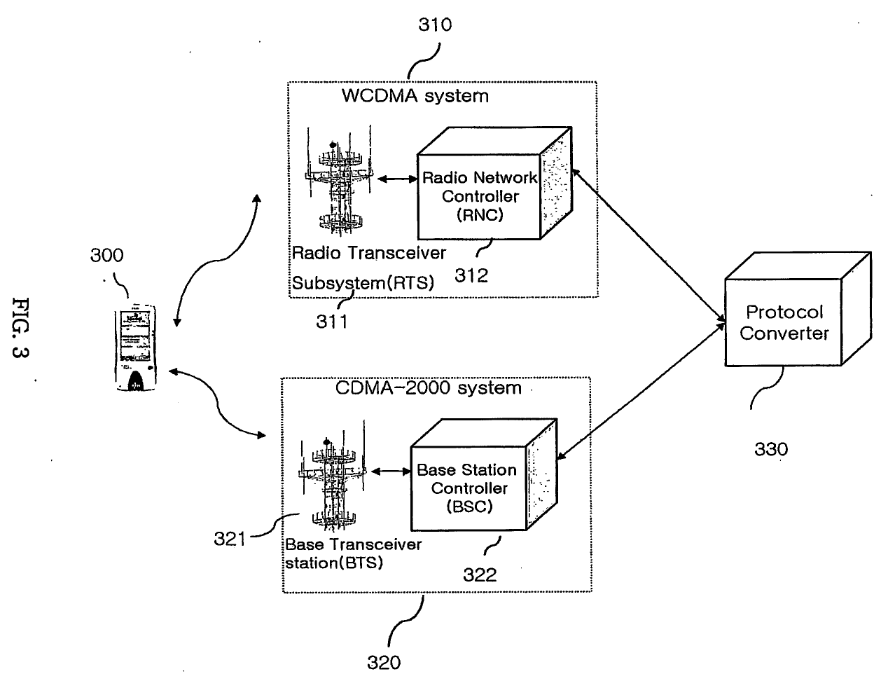

FIG. 3 is a block diagram showing a system performing a handover from a WCDMA network to a CDMA-2000 network by means of a dummy pilot signal according to a preferred embodiment of the present invention.

As shown in FIG. 3, the system performing the handover from the WCDMA network to the CDMA-2000 network by using the dummy pilot signal according to the preferred embodiment of the present invention may include a multimode terminal 300, a WCDMA system 310, a CDMA-2000 system 320, a protocol converter 330, etc.

When the multimode terminal 300 according to the preferred embodiment of the present invention receives a WCDMA signal level measurement message and detects a dummy pilot signal above a specific level from the WCDMA signal level measurement message, the multimode terminal 300 turns on a CDMA-2000 modem and transmits the level value of the dummy pilot signal to the WCDMA system 310. Further, the multimode terminal 300 periodically searches a Common Pilot Channel (hereinafter, referred to as CPICH) and receives the WCDMA signal level measurement message. In the CPICH, one slot consists of 2560 chips and includes 10 symbols of 20 bits. Further, one frame is constructed by 15 slots and the entire number of frames is 72.

The multimode terminal 300 according to the preferred embodiment of the present invention is capable of using both synchronous CDMA-2000 service and asynchronous WCDMA service and using at least two frequency bands. Accordingly, the multimode terminal 300 includes both a CDMA-2000 modem and a WCDMA modem.

Further, when the multimode terminal 300 according to the preferred embodiment of the present invention receives a handover command message from the WCDMA system 310, traffic is switched to the CDMA-2000 modem of the multimode terminal 300. That is, the CDMA-2000 modem of the multimode terminal 300 is turned on and the WCDMA modem of the multimode terminal 300 is turned off.

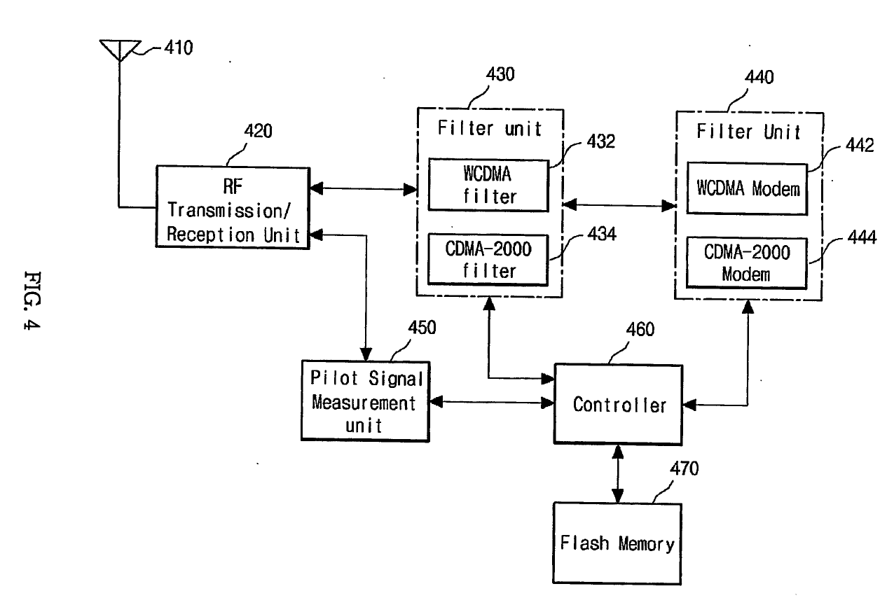

The detailed construction of the multimode terminal 300 will be described with reference to FIG. 4 later.

The WCDMA system 310 according to the preferred embodiment of the present invention receives the level value of the dummy pilot signal from the multimode terminal 300 and determined whether to perform a handover or not. As a result of the determination, the WCDMA system 310 transmits a handover request message to the CDMA-2000 system 320 or the handover command message to the multimode terminal 300. Further, the WCDMA system 310 transmits the WCDMA signal level measurement message to the multimode terminal 300. Herein, the WCDMA signal level measurement message includes information on peripheral base stations which should be searched by the multimode terminal 300 and information on dummy pilot signals.

The WCDMA system 310 according to the preferred embodiment of the present invention may include a Radio Transceiver Subsystem 311 (hereinafter, referred to as RTS), a Radio Network Controller 312 (hereinafter, referred to as RNC), etc.

The RTS 311 of the WCDMA system 310 performs a wireless connection termination function with the multimode terminal 300 conforming to a 3GPP wireless connection standard, transmits/receives voice, image and data traffic using a WCDMA scheme, and transmits/receives information to/from the multimode terminal 300 through a transmission/reception antenna. Further, the RTS 311 according to the preferred embodiment of the present invention receives the level value of the dummy pilot signal from the multimode terminal 300 and transmits the received level value of the dummy pilot signal to the RNC 312.

The RNC 312 of the WCDMA system 310 takes charge of a management function for the RTS 311 and a radio controller such as a Resource Management, a terminal protocol matching, a base station protocol matching, a soft handover processing, a core network protocol processing, a system loading and a failure management. The RNC 312 according to the preferred embodiment of the present invention receives the level value of the dummy pilot signal from the RTS 311 and determines whether to perform a handover for the multimode terminal 300 or not on the basis of the received level value. When it is determined to perform the handover, the RNC 312 transmits the handover request message to the CDMA-2000 system 320. Then, when receiving a response message for the transmitted handover request message, the RNC 312 transmits the handover command message to the multimode terminal 300.

The CDMA-2000 system 320 according to the preferred embodiment of the present invention sends a dummy pilot signal to the multimode terminal 300. Herein, the dummy pilot signal is a WCDMA pilot signal and includes a specific scrambling code assigned in advance in order to be distinguished from other pilot signals.

The CDMA-2000 system 320 according to the preferred embodiment of the present invention may include a BTS 321 and a BSC 322.

The BTS 321 of the CDMA-2000 system 320 performs a baseband signal processing, a wire/wireless conversion, transmission/reception of wireless signals, etc., and is an endpoint apparatus directly connected to the multimode terminal 300. The BTS 321 according to the preferred embodiment of the present invention sends the dummy pilot signal to the multimode terminal 300. Herein, the dummy pilot signal is transmitted from the BTS 321 located in the border area between the WCDMA region and the CDMA-2000 region.

The BSC 322 of the CDMA-2000 system 320 controls and manages a plurality of BTSs 321 and performs general functions required for processing a wireless call. That is, the BSC 322 performs a wireless channel assignment and release function for the multimode terminal 300, transmission power control function of the multimode terminal 300 and the BTS 321, determination function of a soft handover and a hard handover between cells, a transcoding function and a vocoding function, a global positioning system (GPS) clock distribution function, management and maintenance function for the BTS 321, etc. The BSC 322 according to the preferred embodiment of the present invention receives the handover request message from the RNC 312 of the WCDMA system 310 and transmits a response message for the handover request message.

The protocol converter 330 according to the preferred embodiment of the present invention performs a function of converting a protocol of a message exchanged between the WCDMA system 310 and the CDMA-2000 system 320 for interworking between the two systems.

FIG. 4 is a block diagram showing the construction of the multimode terminal 300 according to a preferred embodiment of the present invention.

The multimode terminal 300 according to the preferred embodiment of the present invention may include an RF antenna 410, an RF transmission/reception unit 420, a filter unit 430, a modem unit 440, a pilot signal measurement unit 450, a controller 460, a flash memory 470, etc.

The RF antenna 410 according to the preferred embodiment of the present invention receives RF signals sent from peripheral wireless base stations and transmits the received RF signals to the RF transmission/reception unit 420. The RF transmission/reception unit 420 receives the RF signals from the RF antenna 410, demodulates the received RF signals, and transmits demodulated RF signals to the filter unit 430. Further, the transmission/reception unit 420 modulates transmission data received through the filter unit 430 and the modem unit 440 under the control of the controller 460, and sends the modulated transmission data through the RF antenna 410.

The filter unit 430 according to the preferred embodiment of the present invention includes a WCDMA filter 432 for a WCDMA service and a CDMA-2000 filter 434 for a CDMA-2000 service. Similarly, the modem unit 440 according to the preferred embodiment of the present invention includes a WCDMA modem 442 for the WCDMA service and a CDMA-2000 modem 444 for the CDMA-2000 service. The filter unit 430 extracts only desired digital signals from the demodulated RF signals received from the transmission/reception unit 420 according to operation modes of the multimode terminal 300 by means of the WCDMA filter 432 and the CDMA-2000 filter 434. Then, the filter unit 430 sends the extracted digital signals to the modem unit 440. Further, the modem unit 440 processes the digital signals received from the filter unit 430 and takes charge of a call processing according to protocols defined in a WCDMA standard and a CDMA-2000 standard.

The pilot signal measurement unit 450 according to the preferred embodiment of the present invention receives WCDMA pilot signals through the RF antenna 410 and the RF transmission/reception unit 420 and measures the intensities of the pilot signals. Then, the pilot signal measurement unit 450 transmits the measured intensities of the pilot signals to the controller 460. Herein, the intensity of the pilot signal is usually measured by an Energy of Carrier/Interference of Others (hereinafter, referred to as Ec/Io). The Ec/Io denotes a ratio of signal intensity of a pilot channel with respect to the magnitude of all received noise and is used as a unit representing the signal quality of a pilot channel. Generally, the Ec/Io has a value of about −1˜−2 dB in a region having light traffic and no overlap of electric waves. Further, the Ec/Io has a value of about −6˜−12 dB in a region having heavy traffic and overlap of electric waves, and about −10 dB in the high floors of high-rise buildings in which electric waves overlap. Further, when the Ec/Io has a value of −10˜14 dB, sound interruption occurs. Furthermore, when the Ec/Io has a value below −14 dB, communication failure occurs.

The controller 460 according to the preferred embodiment of the present invention controls the general operations of the multimode terminal 300, selects one of a WCDMA mode and a CDMA-2000 mode according to the type (WCDMA signals or CDMA-2000 signals) of the received RF signals, and controls the multimode terminal 300 to operate in the selected mode. Further, when a specific operation mode is selected, the controller 460 transmits a control signal to the modem unit 440 and controls a specific corresponding one of the WCDMA modem 442 and the CDMA-2000 modem 444 to be turned-on.

Specifically, the controller 460 checks the level value of the dummy pilot signal received from the pilot signal measurement unit 450 and continuously determines whether or not the level value is smaller than a threshold value preset for the operation of the CDMA-2000 modem 444. When the measured level value of the dummy pilot signal begins to decrease to a level lower than the threshold value, the controller 460 turns on the CDMA-2000 modem 444 and controls the measured level value of the dummy pilot signal to be transmitted to the RTS 311 of the WCDMA system 310.

In the preferred embodiment of the present invention, the flash memory 470 stores an inter-modem switching program for allowing the controller 460 to quickly perform switching between the modems by means of the level value of the dummy pilot signal received from the pilot signal measurement unit 450. Accordingly, when the level value measured by the pilot signal measurement unit 450 is smaller than the predetermined threshold value, the controller 460 loads the inter-modem switching program stored in the flash memory 470.

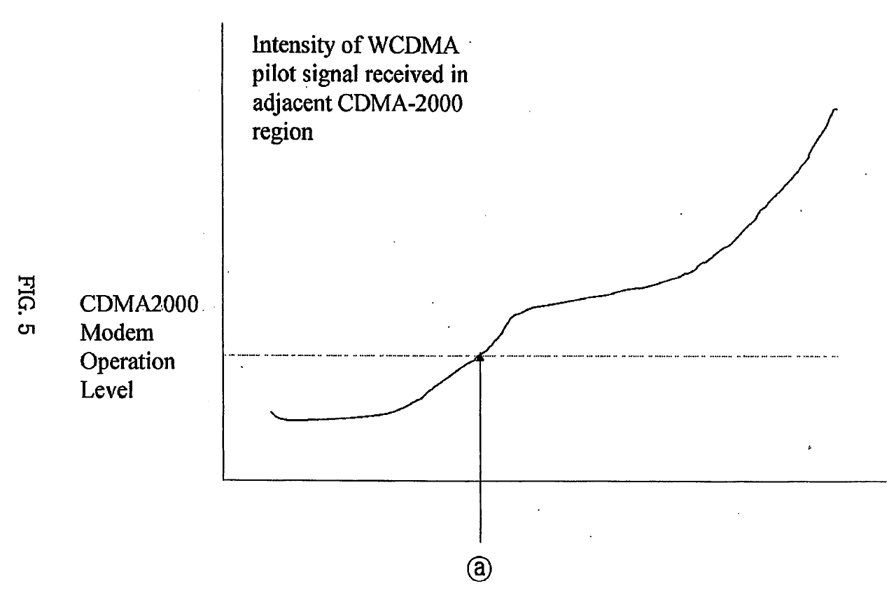

FIG. 5 is a diagram illustrating an operation condition of the CDMA-2000 modem 444 when the multimode terminal 300 moves from the WCDMA regions 220 and 230 to the CDMA-2000 region 210 according to a preferred embodiment of the present invention.

The multimode terminal 300 operating in a WCDMA mode in the WCDMA regions 220 and 230 controls the CDMA-2000 modem 444 to be turned-on at a point @at which the level value of the WCDMA dummy pilot signal received from the BTS 321 of the CDMA-2000 system 320 begins to decrease to a level lower than the threshold value of a predetermined level value.

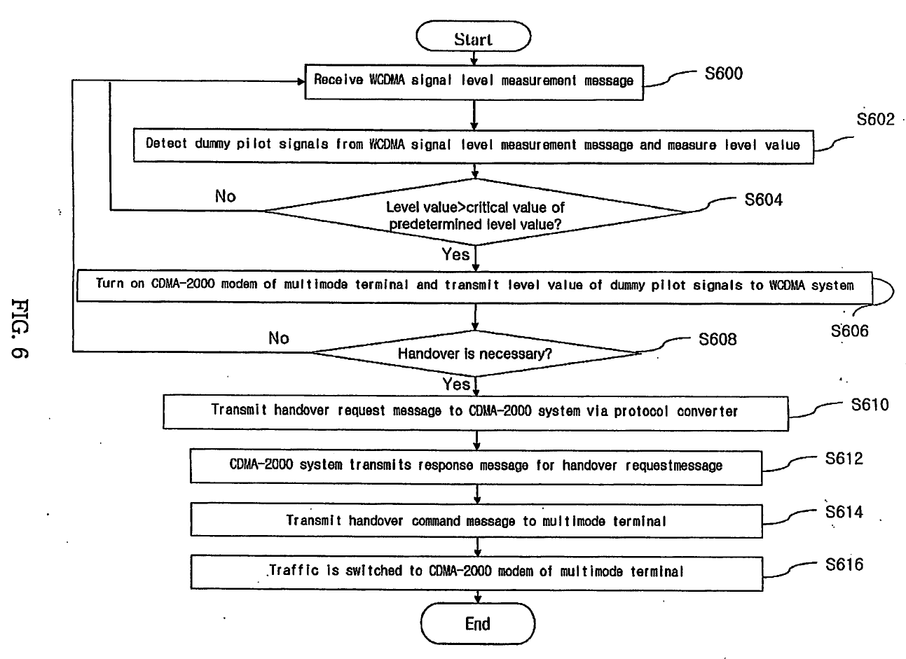

FIG. 6 is a flow diagram illustrating a handover process using a dummy pilot signal from a WCDMA network to a CDMA-2000 network according to a preferred embodiment of the present invention.

First, the multimode terminal 300 receives a WCDMA signal level measurement message transmitted from the WCDMA system 310 (S600). The transmitted/received WCDMA signal level measurement message includes information on peripheral base stations which must be searched by the multimode terminal 300 and information on dummy pilot signals. The multimode terminal 300 having received the WCDMA signal level measurement message detects the dummy pilot signals from the WCDMA signal level measurement message and measures the level value of the dummy pilot signals (S602).

Then, the multimode terminal 300 compares the measured level value with the threshold value of a predetermined level value (S604). As a result of the comparison, when the measured level value is larger than the threshold value of the predetermined level value, the multimode terminal 300 turns on the CDMA-2000 modem 444 and transmits the level value of the dummy pilot signals to the WCDMA system 310 (S606).

The WCDMA system 310 determines whether to perform a handover with the CDMA-2000 network or not on the basis of the value measured by and transmitted from the multimode terminal 300 (S608). Herein, the WCDMA system 310 must inform the BSC 322 of the CDMA-2000 system 320 of the determination result. That is, when it is determined that the handover is necessary, the WCDMA system 310 must transmit a handover request message to the BSC 322 of the CDMA-2000 system 320 (S610). Herein, since the protocol structure of a transmitted/received message changes according to a WCDMA scheme and a CDMA-2000 scheme, the RNC 312 of the WCDMA system 310 cannot directly transmit the handover request message to the BSC 322 of the CDMA-2000 system 320. Accordingly, the RNC 312 of the WCDMA system 310 first transmits the handover request message to the protocol converter 330 for protocol conversion. Then, the protocol converter 330 converts the protocol of the handover request message and transmits the converted handover request message to the BSC 322 of the CDMA-2000 system 320.

The BSC 322 of the CDMA-2000 system 320 having received the handover request message transmits a response message for the handover request message to the RNC 312 of the WCDMA system 310 via the protocol converter 330 (S612). The RNC 312 of the WCDMA system 310 transmits a handover command message to the multimode terminal 300 on the basis of the request message (S614). Then, when the multimode terminal 300 receives the handover command message, the multimode terminal 300 controls traffic to be switched to the CDMA-2000 modem 444 having been already turned on (S616).

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

### INDUSTRIAL APPLICABILITY

According to the present invention as described above, a handover is performed when a multimode terminal moves from a WCDMA network to a CDMA-2000 network. Therefore, even though a subscriber in voice communication in the WCDMA network moves to the CDMA-2000 network, a call interruption does not occur and the subscriber can continuously communicate with an opponent subscriber.

Further, according to the present invention, it is possible to perform a handover even without detecting the signals of a CDMA-2000 network while a multimode terminal receives a service using a WCDMA scheme. Further, it is possible to perform a handover of good performance even without randomly changing a message defined in an international standard. Therefore, it is possible to perform a handover using an existing system.

Consequently, the present invention can provide superior call quality to mobile communication providers and allow the mobile communication providers to increase the flexibility of a network.

1. A method for performing a handover from a WCDMA network to a CDMA-2000 network by using a dummy pilot signal, the method comprising the steps of:
(a) receiving a WCDMA signal level measurement message at a multimode terminal, turning on a CDMA-2000 modem mounted on the multimode terminal and transmitting a level value of the dummy pilot signal to a WCDMA system, upon detecting the dummy pilot signal above a prescribed level out of the WCDMA signal level measurement message;
(b) determining whether to perform a handover or not based on the level value of the dummy pilot signal received from the multimode terminal;
(c) transmitting a handover request message from the WCDMA system to a CDMA-2000 system when it is determined to perform the handover;
(d) transmitting a handover command message from the WCDMA system to the multimode terminal; and
(e) allowing traffic to be switched to the CDMA-2000 modem of the multimode terminal.

2. The method as claimed in claim 1, wherein step (c) includes the steps of:
(c1) transmitting the handover request message from the WCDMA system to a protocol converter when it is determined to perform the handover;
(c2) performing a protocol conversion for the handover request message at the protocol converter; and
(c3) transmitting the protocol-converted handover request message from the protocol converter to the CDMA-2000 system.

3. The method as claimed in claim 1, wherein the WCDMA signal level measurement message includes information on peripheral base stations which should be searched by the multimode terminal and information on the dummy pilot signal.

4. The method as claimed in claim 1, wherein the dummy pilot signal includes a WCDMA pilot signal.

5. The method as claimed in claim 1, wherein the dummy pilot signal is transmitted from the CDMA-2000 system located in a border area between the WCDMA network and the CDMA-2000 network.

6. The method as claimed in claim 1, wherein the dummy pilot signal includes a specific scramble code.

7. The method as claimed in claim 1, wherein the WCDMA system includes:
a radio transceiver subsystem (RTS) for receiving the level value of the dummy pilot signal from the multimode terminal and transmitting the level value of the dummy pilot signal; and
a radio network controller for receiving the level value of the dummy pilot signal from the radio transceiver subsystem, determining whether to perform the handover for the multimode terminal, and transmitting the handover request message or the handover command message.

8. The method as claimed in claim 1, wherein the CDMA-2000 system includes:
a base transceiver station (BTS) for transmitting the dummy pilot signal to the multimode terminal; and
a base station controller (BSC) for receiving the handover request message from the WCDMA system.

9. The method as claimed in claim 1, wherein, at step (a), the multimode terminal periodically searches a common pilot channel (CPICH) and receives the WCDMA signal level measurement message.

10. The method as claimed in claim 1, wherein, at step (d), when the multimode terminal receives the handover command message, the CDMA-2000 modem of the multimode terminal is turned on and a WCDMA modem of the multimode terminal is turned off.

11. A method for performing a handover from a WCDMA network to a CDMA-2000 network by means of a WCDMA system for determining whether to perform the handover or not, a CDMA-2000 system for transmitting a dummy pilot signal, and a multimode terminal including a WCDMA modem and a CDMA-2000 modem, the method comprising the steps of:
(a) receiving a WCDMA signal level measurement message at a multimode terminal;
(b) detecting the dummy pilot signal from the WCDMA signal level measurement message and comparing a level value of the dummy pilot signal with a predetermined threshold value;
(c) turning on a CDMA-2000 modem and transmitting the level value of the dummy pilot signal to the WCDMA system, when the level value of the dummy pilot signal is larger than the predetermined threshold value;
(d) determining whether to perform the handover or not based on the level value of the dummy pilot signal at the WCDMA system;
(e) transmitting a handover request message to the CDMA-2000 system when it is determined to perform the handover at the WCDMA system;
(f) transmitting a handover command message from the WCDMA system to the multimode terminal; and
(g) allowing traffic to be switched to the CDMA-2000 modem of the multimode terminal.

12. The method as claimed in claim 11, wherein step
(e) includes the steps of:
(e1) transmitting the handover request message to a protocol converter when it is determined to perform the handover at the WCDMA system;
(e2) performing a protocol conversion for the handover request message at the protocol converter; and
(e3) transmitting the protocol-converted handover request message to the CDMA-2000 system at the protocol converter.

13. The method as claimed in claim 11, wherein the WCDMA signal level measurement message includes information on peripheral base stations which should be searched by the multimode terminal and information on the dummy pilot signal.

14. The method as claimed in claim 11, wherein the dummy pilot signal includes a WCDMA pilot signal.

15. The method as claimed in claim 11, wherein the dummy pilot signal is transmitted from the CDMA-2000 system located in a border area between the WCDMA network and the CDMA-2000 network.

16. The method as claimed in claim 11, wherein the dummy pilot signal includes a specific scramble code.

17. The method as claimed in claim 11, wherein the WCDMA system comprises:
a radio transceiver subsystem (RTS) for receiving the level value of the dummy pilot signal from the multimode terminal and transmitting the level value of the dummy pilot signal; and
a radio network controller for receiving the level value of the dummy pilot signal from the radio transceiver subsystem, determining whether to perform the handover for the multimode terminal, and transmitting the handover request message or the handover command message.

18. The method as claimed in claim 11, wherein the CDMA-2000 system includes:
a base transceiver station (BTS) for transmitting the dummy pilot signal to the multimode terminal; and
a base station controller (BSC) for receiving the handover request message from the WCDMA system.

19. The method as claimed in claim 11, wherein, in step a), the multimode terminal periodically searches a common pilot channel (CPICH) and receives the WCDMA signal level measurement message.

20. The method as claimed in claim 11, in step f), when the multimode terminal receives the handover command message, the CDMA-2000 modem of the multimode terminal is turned on and a WCDMA modem of the multimode terminal is turned off.

21. A system for performing a handover from a WCDMA network to a CDMA-2000 network by means of a dummy pilot signal, the system comprising:
a multimode terminal for receiving a WCDMA signal level measurement message, turning on a CDMA-2000 modem embedded in the multimode terminal and transmitting a level value of the dummy pilot signal, when detecting the dummy pilot signal above a prescribed level out of the WCDMA signal level measurement message;
a WCDMA system for receiving the level value of the dummy pilot signal from the multimode terminal, determining whether to perform the handover, and transmitting a handover request message or a handover command message; and
a CDMA-2000 system for transmitting the dummy pilot signal to the multimode terminal.

22. The system as claimed in claim 21, further comprising a protocol converter for converting a protocol of messages transferred between the WCDMA system and the CDMA-2000 system.

23. The system as claimed in claim 21, wherein the multimode terminal is capable of using both synchronous CDMA-2000 service and an asynchronous WCDMA service and uses at least two frequency bands.

24. The system as claimed in claim 21, wherein, when the multimode terminal receives the handover command message, traffic is switched to the CDMA-2000 modem of the multimode terminal.

25. The system as claimed in claim 21, wherein the WCDMA signal level measurement message includes information on peripheral base stations which should be searched by the multimode terminal and information on the dummy pilot signal.

26. The system as claimed in claim 21, wherein the dummy pilot signal includes a WCDMA pilot signal.

27. The system as claimed in claim 21, wherein the dummy pilot signal is transmitted from the CDMA-2000 system located in a border area between the WCDMA network and the CDMA-2000 network.

28. The system as claimed in claim 21, wherein the dummy pilot signal includes a specific scramble code.

29. The system as claimed in claim 21, wherein the WCDMA system includes:
a radio transceiver subsystem (RTS) for receiving the level value of the dummy pilot signal from the multimode terminal and transmitting the received level value of the dummy pilot signal; and
a radio network controller for receiving the level value of the dummy pilot signal from the radio transceiver subsystem, determining whether to perform the handover for the multimode terminal, and transmitting the handover request message or the handover command message.

30. The system as claimed in claim 21, wherein the CDMA-2000 system includes:
a base transceiver station (BTS) for transmitting the dummy pilot signal to the multimode terminal; and
a base station controller (BSC) for receiving the handover request message from the WCDMA system.

31. The system as claimed in claim 21, wherein the multimode terminal periodically searches a common pilot channel (CPICH) and receives the WCDMA signal level measurement message.

32. The system as claimed in claim 21, wherein, when the multimode terminal receives the handover command message, the CDMA-2000 modem of the multimode terminal is turned on and a WCDMA modem of the multimode terminal is turned off.

33. A WCDMA system for performing a handover from a WCDMA network to a CDMA-2000 network by means of a dummy pilot signal, the WCDMA system comprising:
a radio transceiver subsystem (RTS) for receiving a level value of the dummy pilot signal from a multimode terminal and transmitting the received level value of the dummy pilot signal; and
a radio network controller for receiving the level value of the dummy pilot signal from the radio transceiver subsystem, determining whether to perform the handover for the multimode terminal, and transmitting a handover request message or a handover command message.

34. The WCDMA system as claimed in claim 33, wherein the multimode terminal is capable of using both synchronous CDMA-2000 service and asynchronous WCDMA service and uses at least two frequency bands.

35. The WCDMA system as claimed in claim 33, wherein, when the multimode terminal receives the handover command message, traffic is switched to a CDMA-2000 modem of the multimode terminal.

36. The WCDMA system as claimed in claim 33, wherein the dummy pilot signal includes a WCDMA pilot signal.

37. The WCDMA system as claimed in claim 33, wherein the dummy pilot signal includes a specific scramble code.

38. The WCDMA system as claimed in claim 33, wherein, when the multimode terminal receives the handover command message, a CDMA-2000 modem of the multimode terminal is turned on and a WCDMA modem of the multimode terminal is turned off.

39. A CDMA-2000 system for performing a handover from a WCDMA network to a CDMA-2000 network by means of a dummy pilot signal, the CDMA-2000 system comprising:
a base transceiver station (BTS) for transmitting the dummy pilot signal, which is a WCDMA pilot signal including a specific scramble code assigned in advance, to the multimode terminal; and
a base station controller (BSC) for receiving a handover request message from a WCDMA system.

40. The CDMA-2000 system as claimed in claim 39, wherein the multimode terminal is capable of using both synchronous CDMA-2000 service and an asynchronous WCDMA service and uses, at least two frequency bands.

41. The CDMA-2000 system as claimed in claim 39, wherein, when the multimode terminal receives a handover command message, traffic is switched to a CDMA-2000 modem of the multimode terminal.

42. The CDMA-2000 system as claimed in claim 39, wherein, when traffic is switched to a CDMA-2000 modem, the multimode terminal turns off a WCDMA modem mounted on an inside of the multimode terminal.

43. The CDMA-2000 system as claimed in claim 39, wherein the multimode terminal periodically searches a common pilot channel (CPICH) and receives the dummy pilot signal.

44. The CDMA-2000 system as claimed in claim 39, wherein, when the multimode terminal receives a handover command message, a CDMA-2000 modem of the multimode terminal is turned on and a WCDMA modem of the multimode terminal is turned off.

45. A multimode terminal capable of using both synchronous CDMA-2000 service and asynchronous WCDMA service and using at least two frequency bands, the multimode terminal comprising:
an RF antenna for transmitting/receiving CDMA-2000 signals and/or WCDMA signals;
an RF transmission/reception unit for receiving and demodulating a dummy pilot signal sent from the RF antenna, and outputting a demodulated dummy pilot signal;
a pilot signal measurement unit for measuring intensity of the demodulated dummy pilot signal;
a WCDMA modem and a CDMA-2000 modem for processing a digital signal received from the RF transmission/reception unit and performing a call processing according to protocols respectively defined in a WCDMA standard and a CDMA-2000 standard;
a flash memory for storing an inter-modem switching program for performing a switching between the WCDMA modem and the CDMA-2000 modem according to a command from a WCDMA system; and
a controller for turning on the CDMA-2000 modem and controlling a level value of the dummy pilot signal to be transmitted to the WCDMA system, when the dummy pilot signal above a specific level is detected.

46. The multimode terminal as claimed in claim 45, wherein, when the multimode terminal receives a handover command message from the WCDMA system, the controller loads the inter-modem switching program, controls the CDMA-2000 modem to be turned on, and controls the WCDMA modem to be turned off.

47. The multimode terminal as claimed in claim 45, wherein the dummy pilot signal includes a WCDMA pilot signal.

48. The multimode terminal as claimed in claim 45, wherein the dummy pilot signal is transmitted from a CDMA-2000 system located in a border area of a WCDMA network and a CDMA-2000 network.

49. The multimode terminal as claimed in claim 45, wherein the dummy pilot signal includes a specific scramble code assigned in advance.

50. The multimode terminal as claimed in claim 45, wherein the WCDMA system comprises:
a radio transceiver subsystem (RTS) for receiving the level value of the dummy pilot signal from the multimode terminal and transmitting the received level value of the dummy pilot signal; and
a radio network controller for receiving the level value of the dummy pilot signal from the radio transceiver subsystem, determining whether to perform the handover for the multimode terminal, and transmitting a handover request message or a handover command message.

51. The multimode terminal as claimed in claim 45, wherein the multimode terminal periodically searches a common pilot channel (CPICH) and receives the CDMA-2000 signals and/or the WCDMA signals.
